(19) United States
(12) Patent Application Publication
(10) Pub. No.: US 2025/0210761 A1
(43) Pub. Date: Jun. 26, 2025

(54) Secondary Battery

(71) Applicant: SK On Co., Ltd., Seoul (KR)

(72) Inventors: Suk Chan KIM, Daejeon (KR); Soo Min PARK, Daejeon (KR); Hyung Ju PAIK, Daejeon (KR); Hae Ryong JEON, Daejeon (KR); Won Tae HEO, Daejeon (KR); Soo In PARK, Seoul (KR)

(21) Appl. No.: 18/935,806

(22) Filed: Nov. 4, 2024

(30) Foreign Application Priority Data
Dec. 20, 2023 (KR) 10-2023-0187374

(51) Int. Cl. H01M 50/133; H01M 50/121; H01M 50/124; H01M 50/169; H01M 50/171

(52) U.S. Cl. CPC H01M 50/133; H01M 50/121; H01M 50/124; H01M 50/169; H01M 50/171

(57) ABSTRACT

A secondary battery is disclosed. The secondary battery includes an electrode assembly, an insulating casing accommodating the electrode assembly therein, and a case accommodating the insulating casing therein. The insulating casing includes an upper insulating casing having a first traverse overlapping portion, and a lower insulating casing having a second traverse overlapping portion overlapping the first traverse overlapping portion to form a traverse overlapping portion.

### CROSS-REFERENCE TO RELATED APPLICATION(S)

This patent document claims the priority and benefits of Korean Patent Application No. 10-2023-0187374 filed on Dec. 20, 2023, the disclosure of which is incorporated herein by reference in its entirety.

### TECHNICAL FIELD

The disclosure relates to a secondary battery having an insulating casing.

### BACKGROUND

A secondary battery may be a type of energy storage means that may be charged and discharged. Secondary batteries have been widely used in a variety of devices using electricity as a power source. For example, secondary batteries have been used as an energy storage means in applications ranging from a variety of devices, from small-sized devices such as mobile phones, laptops, tablets, and the like to large-sized devices such as vehicles, aircraft, and the like. In particular, recently, secondary batteries have been actively researched for use as vehicle power sources.

Secondary batteries may be classified as lead-acid batteries, nickel-cadmium batteries, nickel-hydrogen batteries, lithium-ion batteries, and the like, depending on a material of an electrode or the like. A type of secondary battery may be appropriately selected depending on a design capacity, a usage environment, or the like. Lithium-ion batteries may have relatively high voltages and levels of capacitance, as compared to other types of secondary batteries. Accordingly, lithium-ion batteries have been widely used in devices within fields requiring high-density energy storage means such as vehicle battery packs and the like.

Secondary batteries, such as lithium-ion batteries, may include a positive electrode, a negative electrode, a separator, an electrolyte, and the like, as main components. The positive electrode and the negative electrode are disposed with a separator formed of an insulating material therebetween, and may be charged or discharged by the movement of ions through the electrolyte.

In some types of secondary batteries, an electrode assembly including a positive electrode, a negative electrode, a separator, and the like may be accommodated in an insulating bag. The insulating bag may be provided as a flexible sheet made of a synthetic resin material such as polypropylene or the like, and formed to surround an external surface of the electrode assembly. In other types of secondary batteries, the insulating bag described above may be replaced by an insulating casing having a predetermined thickness. The insulating casing may form a predetermined internal space, and may be formed to accommodate the electrode assembly in the internal space.

The above description is provided to help understand the technical background of the present disclosure and should not be construed to reduce, limit, or restrict the technical idea of the present disclosure. In addition, technical features described or suggested in the above description do not necessarily mean the prior art, and some technical features may not correspond to those of the prior art.

### SUMMARY

According to an aspect of the present disclosure provides a secondary battery capable of implementing a further improved reinforcing structure through an insulating casing.

However, technical issues to be achieved by embodiments of the present disclosure are not necessarily limited to the above-described technical issues. Other technical issues, not described, may be clearly understood by those skilled in the art to which the present disclosure belongs from other descriptions in the specification, such as detailed descriptions.

A secondary battery of the present disclosure may be widely applied in the field of green technology, such as to electric vehicles, battery charging stations, and other battery-utilizing solar power generation schemes, wind power generation schemes, or the like. In addition, the secondary battery of the present disclosure may be used in eco-friendly electric vehicles, hybrid vehicles, and the like, to prevent climate change by suppressing air pollution and greenhouse gas emissions.

According to an aspect of the present disclosure, there is provided a secondary battery including an electrode assembly, an insulating casing accommodating the electrode assembly therein, and a case accommodating the insulating casing therein. The insulating casing may include an upper insulating casing having a first traverse overlapping portion, and a lower insulating casing having a second traverse overlapping portion overlapping the first traverse overlapping portion to form a traverse overlapping portion.

The transverse overlapping portion may be formed to have a closed shape surrounding a circumference of the insulating casing in plan view.

The transverse overlapping portion may be disposed in a central region of the insulating casing in a height direction.

The first and second transverse overlapping portions may overlap each other in a thickness direction of the insulating casing, and may be coupled to each other through thermal fusion or an adhesive means.

One-side end of the upper insulating casing may overlap a corresponding opposite-side end of the upper insulating casing to form a first longitudinal overlapping portion. One-side end of the lower insulating casing may overlap a corresponding opposite-side end of the lower insulating casing to form a second longitudinal overlapping portion.

The first and second longitudinal overlapping portions may be disposed on one surface of the insulating casing to vertically correspond to each other, and may be formed to intersect the transverse overlapping portion in a “+” shape.

The transverse overlapping portion may be formed to have a predetermined height by the first and second transverse overlapping portions overlapping each other, and the height may be formed to be slightly greater than a width of an overlap between the first and second longitudinal overlapping portions.

One of the first and second traverse overlapping portions may be formed to extend through a bending region, and the bending region may be formed to be bent toward the outside of the insulating casing such that an internal surface of the insulating casing forms a plane at a bonding portion between the first and second traverse overlapping portions.

The first traverse overlapping portion may include a first protruding rib formed to protrude toward the outside of the insulating casing, the first protruding rib formed as a plurality of first protruding ribs, the plurality of first protruding ribs disposed to be spaced apart from each other at a predetermined interval in an extension direction of the first traverse overlapping portion, and a first rib groove formed between a pair of adjacent first protruding ribs, the first rib groove disposed repeatedly and alternately with the first protruding rib in the extension direction.

The second traverse overlapping portion may include a second protruding rib formed as a plurality of first protruding ribs, the plurality of second protruding ribs disposed to be spaced apart from each other at predetermined interval in the extension direction of the second traverse overlapping portion, the second protruding rib coupled to the first rib groove to be engaged with the first rib groove, and a second rib groove formed between a pair of adjacent second protruding ribs, the second rib groove coupled to the first protruding rib be engaged with the first protruding rib.

The first traverse overlapping portion may be formed by a lower end region of the upper insulating casing being bent. The second traverse overlapping portion may be formed by an upper end region of the lower insulating casing being bent so as to correspond to the first traverse overlapping portion. The traverse overlapping portion may be formed by bent portions of the first and second traverse overlapping portions, vertically overlapping each other.

The first traverse overlapping portion may be formed by the lower end region of the upper insulating casing being bent toward the outside of an internal space thereof. The second traverse overlapping portion may be formed by the upper end region of the lower insulating casing being bent toward the outside of an internal space thereof so as to correspond to the first traverse overlapping portion.

At least a portion of the traverse overlapping portion may be bent toward an external surface of the insulating casing after bonding between the first and second traverse overlapping portions.

The traverse overlapping portion may be divided with a predetermined gap at a position at which respective surfaces of the insulating casing are in contact with each other.

The upper insulating casing may include an upper surface portion shielding an upper side of the electrode assembly, the upper surface portion having at least one of a first electrode path, a second electrode path, a vent path, and an injection port path. The lower insulating casing may include a bottom surface portion shielding a lower side of the electrode assembly, the bottom surface portion having an electrolyte flow hole.

The insulating casing may be formed as a plate formed of insulating plastic material having a predetermined thickness.

A secondary battery according to an embodiment of the present disclosure may include an insulating casing accommodating an electrode assembly therein. The insulating casing may be divided into an upper insulating casing and a lower insulating casing, and the upper and lower insulating casings may form a transverse overlapping portion surrounding a circumference of an internal space in a transverse direction. The transverse overlapping portion may function as a reinforcing means for swelling or the like generated in the internal space. In addition, in some cases, the insulating casing may include a longitudinal overlapping portion, and the longitudinal overlapping portion may vertically extend from one surface thereof surrounding the internal space to assist the reinforcing function or the like.

However, technical effects to be obtained by embodiments of the present disclosure are not necessarily limited to the above-described technical effects. Other issues effects, not described, may be clearly understood by those skilled in the art to which the present disclosure belongs from other descriptions in the specification, such as detailed descriptions.

### BRIEF DESCRIPTION OF DRAWINGS

Certain aspects, features, and advantages of the present disclosure are illustrated by the following detailed description with reference to the accompanying drawings.

FIG. 1A is a schematic external perspective view of a secondary battery according to an embodiment.

FIG. 1B is a schematic exploded perspective view of a secondary battery illustrated in FIG. 1A.

FIG. 1C is a schematic internal cross-sectional view of a secondary battery illustrated in FIG. 1A.

FIG. 2A is a schematic perspective view of an insulating casing according to an embodiment.

FIG. 2B is a schematic deployment view of an upper insulating casing illustrated in FIG. 2A.

FIG. 2C is a schematic deployment view of a lower insulating casing illustrated in FIG. 2A.

FIG. 2D is a schematic diagram illustrating an electrode assembly being packaged by an insulating casing illustrated in FIG. 2A.

FIG. 3A is a schematic perspective view of an insulating casing according to another embodiment.

FIG. 3B is a schematic cross-sectional view taken along lines C1-C1′ and C2-C2′ indicated in FIG. 3A.

FIG. 4A is a schematic perspective view of an insulating casing according to another embodiment.

FIG. 4B is a schematic partial deployment view of an insulating casing illustrated in FIG. 4A.

FIG. 4C is a schematic diagram illustrating an electrode assembly being packaged by an insulating casing illustrated in FIG. 4A.

### DETAILED DESCRIPTION

Features of the present disclosure disclosed in this patent document are described by example embodiments with reference to the accompanying drawings.

The present disclosure can be implemented in some embodiments to provide a secondary battery having an insulating casing.

Hereinafter, embodiments of the present disclosure will be described with reference to the attached drawings. For convenience, in the following description, detailed descriptions will be omitted for configurations that obscure the technical gist of the present disclosure or for known configurations.

The following embodiments are provided to more completely describe the present disclosure to those skilled in the art. The following embodiments are provided to aid understanding of the present disclosure, and the technical idea of the present disclosure is not necessarily limited to particular embodiments described below. The present disclosure should be understood to broadly include all changes, equivalents, and replacements within the idea and the technical scope of the disclosure.

The terms used herein are provided to more completely describe specific embodiments from the above-described point of view. Accordingly, the terms used herein should not be construed to reduce, limit, or restrict the technical idea of the present disclosure.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In the following description, the terms such as “first,” “second,” and the like may be used to distinguish specific components from other components. However, the above-described terms are used for the purpose of distinguishing specific components from other components for clarity of description, and the technical idea of respective components should not be limited by the above-described terms.

A secondary battery, described herein, may include a battery that may be charged and discharged. For example, the secondary battery may include a lead-acid battery, a nickel-cadmium battery, a nickel-hydride battery, a lithium-ion battery, or the like. In the present description, it is mainly assumed that the secondary battery is a lithium-ion battery. In general, a lithium-ion battery may have advantages in terms of lightweightedness, high-energy density, and low self-discharge rate. However, it should be understood that the technical concept, described herein, are applicable to other suitable types of batteries other than a lithium-ion battery.

A secondary battery, described herein, may include a single physical unit, or a cluster unit in which a plurality of physical units are combined with each other. For example, a secondary battery may include a battery cell, a battery module, a battery pack, or the like depending on a classification criterion generally used in a current vehicle field. In the present description, it is mainly assumed that that the secondary battery is a battery cell, a single unit. In general, a battery cell may be a basic component unit of a battery pack including a positive electrode, a negative electrode, a separator, an electrolyte, and the like. However, it should be understood that the technical concepts, described herein, are applicable to other suitable types of cluster units such as a battery module, a battery pack, and the like, as necessary.

The secondary battery, described herein, may include various types of packaged secondary batteries. For example, the secondary battery may be packaged to have a cylindrical shape, a prismatic shape, a pouch shape, a coin shape, or the like depending on a classification criterion generally used in a related field. In the present description, it is mainly assumed that the secondary battery is packaged to have a prismatic shape. Prismatic-shaped packaging, referred to as a prismatic-shaped battery or the like, may generally have advantages s in terms of durability, safety, and convenience of mounting. However, it should be understood that the technical concept, described herein, is applicable to other suitable types of packaging such as a cylindrical-shaped packaging, a pouch-shaped packaging, a coin-shaped packaging, or the like, as necessary.

The secondary battery, described in herein, may be used in various means requiring electrical energy. For example, the secondary battery may be suitably used in a vehicle field using electrical energy as a main power source or an auxiliary power source. For another example, the secondary battery may be suitably used in the field of an aircraft such as a personal aircraft, an unmanned aerial vehicle, a drone, or the like, in the field of an electronic device such as a mobile phone, a laptop, a tablet, or the like, and in the field of an electric tool such as an electric drill, an electric grinder, an electric hammer, or the like. However, it should be understood that the secondary battery, described in herein, are applicable in various means operated based on electrical energy in addition to devices within the above-described fields.

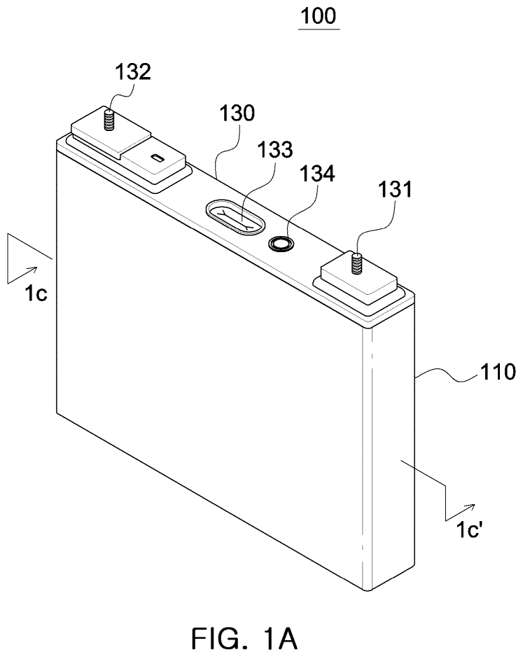

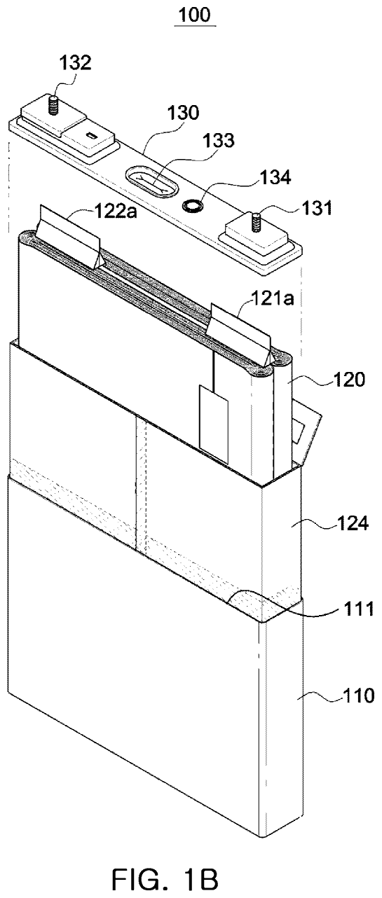

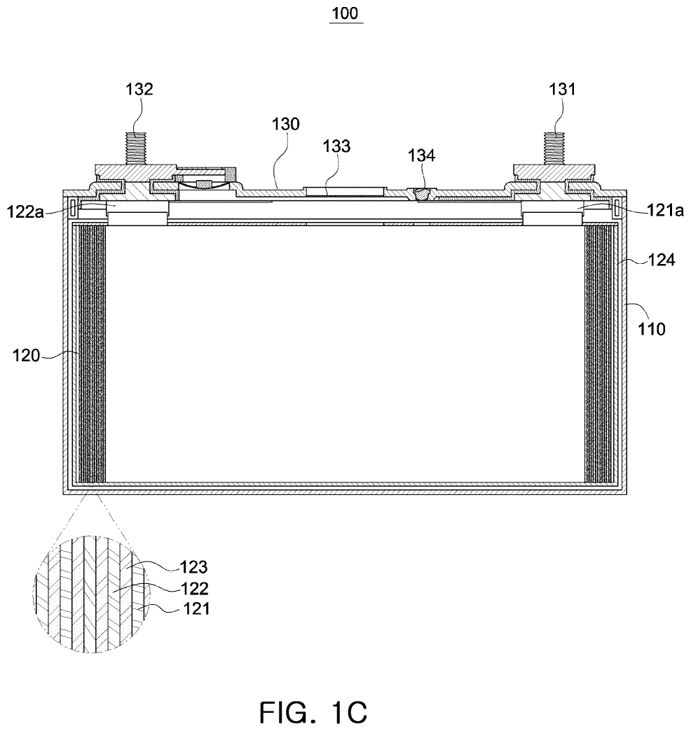

FIG. 1A is a schematic external perspective view of a secondary battery according to an embodiment. FIG. 1B is a schematic exploded perspective view of a secondary battery illustrated in FIG. 1A. FIG. 1C is a schematic internal cross-sectional view of a secondary battery illustrated in FIG. 1A.

For ease of description, in the present embodiment, a single battery cell, packaged to have a prismatic shape, is exemplified.

Referring to FIGS. 1A to 1C, a secondary battery 100 according to the present embodiment may include a case 110.

The case 110 may provide an internal space in which an electrode assembly 120 or the like may be accommodated. In the present embodiment, it is exemplified that the case 110 has an approximately rectangular parallelepiped shape.

The case 110 may include an opening 111 connected to the internal space. In the present embodiment, the opening 111 is exemplified as being provided in an upper end of the case 110. However, a position of the opening 111 may be changed, as necessary, and is not necessarily limited to the example. The opening 111 may function as a path for inserting the electrode assembly 120 or the like. In addition, the opening 111 may function as a connection space for electrical connection between the electrode assembly 120 and an electrode terminal. The opening 111 may be closed by a cap plate 130.

The material of the case 110 may be appropriately selected in consideration of thermal and electrical conductivity, rigidity corresponding to swelling of the electrode assembly 120, machinability, manufacturing costs, or the like. For example, the case 110 may be formed of a metal material including aluminum, an aluminum alloy, or the like.

The secondary battery 100 according to the present embodiment may include the electrode assembly 120.

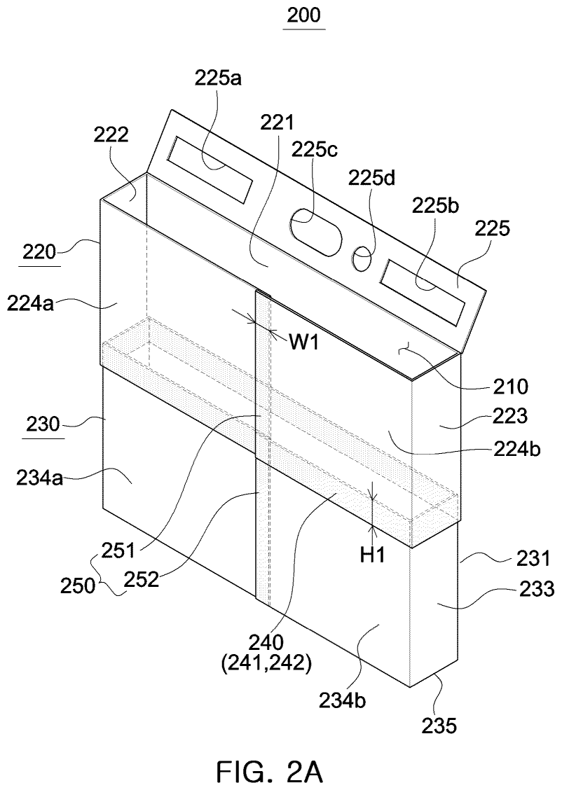

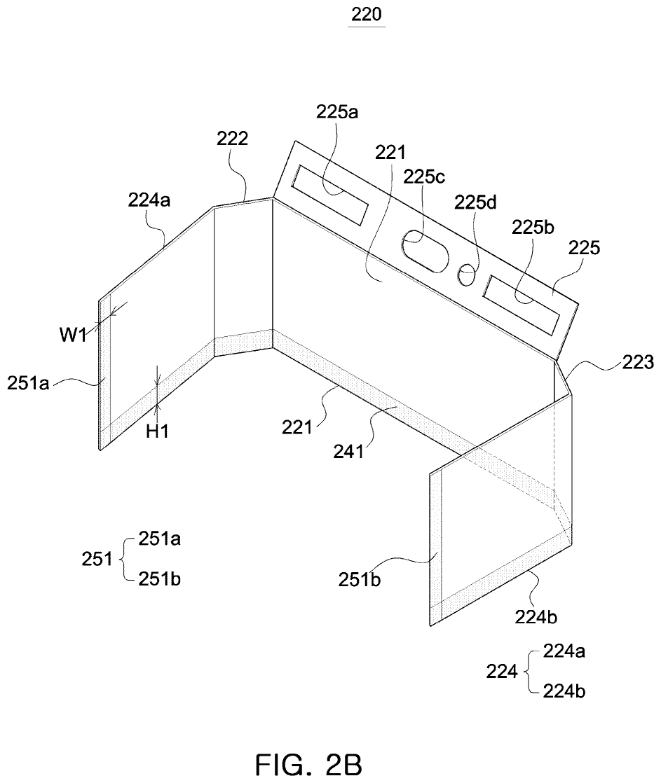

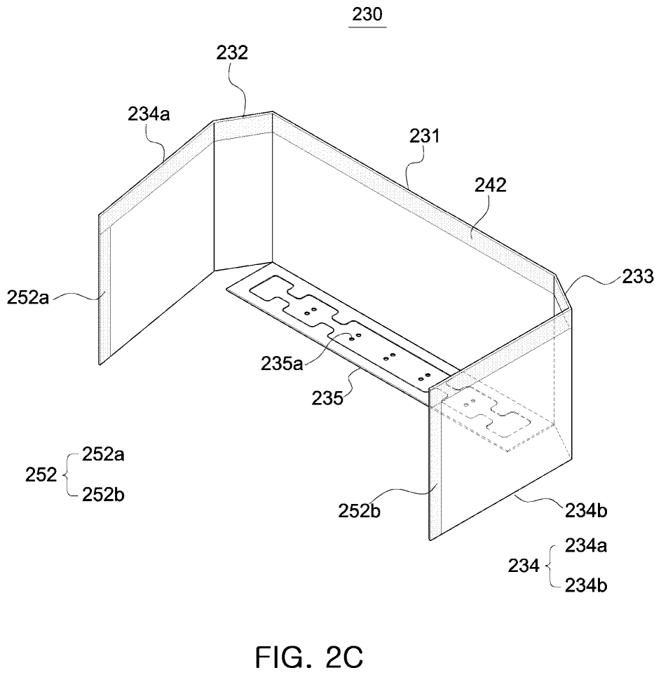

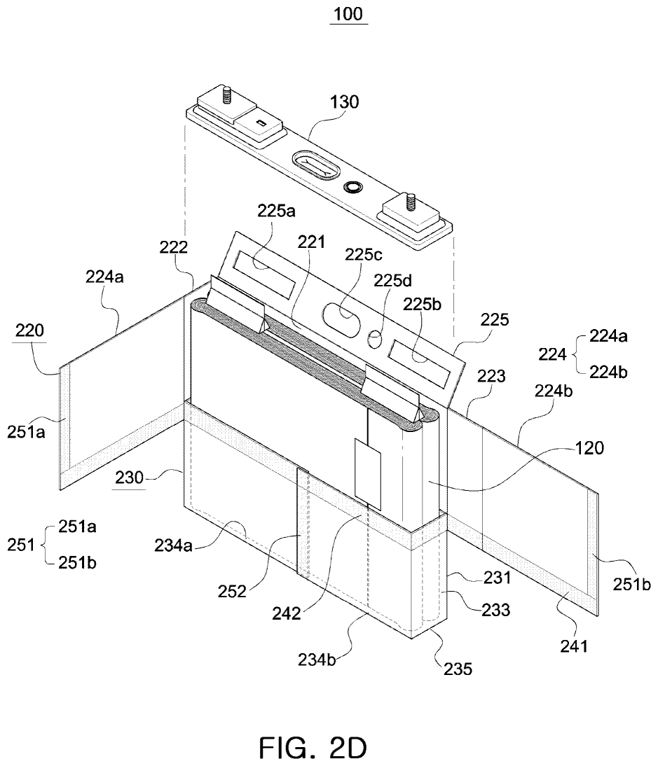

The electrode assembly 120 may be disposed in the internal space of the case 110. In the present embodiment, the electrode assembly 120 may be accommodated in the insulating casing 124 in the case 110. The insulating casing 124 will be further described with reference to FIG. 2A or the like to be described below.

The electrode assembly 120 may include a positive electrode 121. The positive electrode 121 may include a positive electrode current collector and a positive electrode active material. In some embodiments, the positive electrode current collector may include aluminum, an aluminum alloy, or the like, and the positive electrode active material may include lithium cobalt oxide, lithium manganate, lithium nickel oxide, lithium iron phosphate, or the like. The positive electrode active material may be coated on a surface of the positive electrode current collector. A portion of the positive electrode current collector, not coated with the positive electrode active material, may function as a positive electrode tab 121a. In some embodiments, the positive electrode tab 121a may be provided as a plurality of positive electrode tabs 121a, and a portion or all of the plurality of positive electrode tabs 121a may be bonded to each other.

The negative electrode 122 may include a negative electrode. The negative electrode 122 may include a negative electrode current collector and a negative electrode active material. In some embodiments, the negative electrode current collector may include copper, a copper alloy, nickel, a nickel alloy, or the like, and the negative electrode active material may include carbon, silicon, or the like. The negative electrode active material may be coated on a surface of the negative electrode current collector. A portion of the negative electrode current collector, not coated with the negative electrode active material, may function as a negative electrode tab 122a. In some embodiments, the negative electrode tab 122a may be provided as a plurality of negative electrode tabs 122a, and a portion or all of the plurality of negative electrode tabs 122a may be bonded to each other.

The electrode assembly 120 may include a separator 123. The separator 123 may be disposed between the positive electrode 121 and the negative electrode 122. T. The separator 123 may limit physical contact between the positive electrode 121 and the negative electrode 122, and may function to provide a path for movement of ions. In some embodiments, the separator 123 may be formed of a polymer material including polyethylene, polypropylene, or the like. The separator 123 may include a dry separator and a wet separator. In some embodiments, the separator 123 may include a coating layer including a ceramic coating layer or the like.

The electrode assembly 120 may be formed by arranging the components in a winding or stacking manner. For example, the electrode assembly 120 may be formed to have a structure in which the positive electrode 121, the negative electrode 122, and the separator 123 are wound around an axis in a longitudinal direction a or transverse direction. Alternatively, the electrode assembly 120 may be formed to have a structure in which the winding structure is pressed in a direction, approximately perpendicular to a winding axis. The winding structure may be referred to as a “jelly roll” or the like in the art.

For another example, the electrode assembly 120 may be formed to have a structure in which the positive electrode 121, the negative electrode 122, and the separator 123 are stacked. In some cases, in the stack structure, the separator 123 may be formed to have a structure in which a plurality of unit separators 122, continuous in a length direction, are sequentially folded and stacked according to stacking of the positive electrode 121 and the negative electrode 122. The stack structure may be referred to as “stacking and folding” or “z-folding” in the art. However, in the present embodiment, arrangements of respective components of the electrode assembly 120 are not limited. The electrode assembly 120 may have various arrangements other than those exemplified above.

In some embodiments, a plurality of units may be combined with each other in the electrode assembly 120. For example, the electrode assembly 120 may include a unit wound in a jelly-roll manner, and two or more units may be combined with each other to form the electrode assembly 120. In the present embodiment, the electrode assembly 120 may include two jelly roll units, combined with each other. For another example, the electrode assembly 120 may include a unit wound in a “stacking and folding” manner, and two or more units may be combined with each other to form the electrode assembly 120.

The electrode assembly 120 may be accommodated in the internal space of the case 110, together with an electrolyte. In some embodiments, the electrolyte may be formed of an organic solvent including a lithium salt. For example, the lithium salt may include liquid or gel-like lithium hexafluorophosphate (LiPF₆), lithium tetrafluoroborate (LiBF₄), or the like, and the organic solvent may include cyclic carbonate such as ethylene carbonate (EC), propylene carbonate (PC), linear carbonate such as diethyl carbonate (DEC), dimethyl carbonate (DMC), ethyl methyl carbonate (EMC), or the like.

In other embodiments, the electrolyte may be omitted or replaced. For example, when an inorganic material-based solid electrolyte is used, a liquid or gel-like electrolyte may be omitted.

The secondary battery 100 according to the present embodiment may include a cap plate 130.

The cap plate 130 may be formed to close the opening 111. In the present embodiment, the cap plate 130 is exemplified to have a rectangular plate shape corresponding to that of the opening 111. The cap plate 130 may be coupled to the case 110 to seal the internal space of the case 110 in which the electrode assembly 120 is disposed. In some embodiments, the cap plate 130 may be welded to the case 110 by ultrasonic welding, laser welding, or the like.

A positive electrode terminal 131 and a negative electrode terminal 132 may be disposed on the cap plate 130. The positive electrode terminal 131 may be electrically connected to the positive electrode tab 121a of the electrode assembly 120, and the negative electrode terminal 132 may be electrically connected to the negative electrode tab 122a of the electrode assembly 120.

The cap plate 130 may include an electrolyte injection port 134. The electrolyte injection port 134 may be used to inject the electrolyte into the internal space of the case 110. In the present embodiment, the electrolyte injection port 134 may be disposed to be adjacent to a vent 133 in a central region of the cap plate 130, but a position of the electrolyte injection port 134 may be changed in various manners, and is not necessarily limited to the example. The electrolyte injection port 134 may be properly sealed after being subject to injection of the electrolyte, a formation process, or the like. In some embodiments, the electrolyte injection port 134 may be sealed by press-fitting a ball-shaped sealing member formed of a polymer resin.

The cap plate 130 may include a vent 133. In the present embodiment, the vent 133 may be disposed between the positive electrode terminal 131 and the negative electrode terminal 132. However, a position of the vent 133 may be changed in various manners, as necessary, and is not limited to the example. In another embodiment, the vent 133 may be disposed on or added to the case 110. The vent 133 may be formed to be opened corresponding to internal pressure of the case 110. The vent 133 may function to contribute to stabilization of an internal element of the case 110 by discharging the internal pressure to the outside of the case 110.

Hereinafter, the insulating casing 124, accommodating the electrode assembly 120, will be additionally described. Hereinafter, for convenience, an insulating casing according to each embodiment is denoted by a new reference numeral and described.

FIG. 2A is a schematic perspective view of an insulating casing according to an embodiment. FIG. 2B is a schematic deployment view of an upper insulating casing illustrated in FIG. 2A. FIG. 2C is a schematic deployment view of a lower insulating casing illustrated in FIG. 2A.

Referring to FIGS. 2A to 2C, an insulating casing 200 of the present embodiment may form an internal space 210 in which an electrode assembly 120 is accommodated. In the present embodiment, the internal space 210 is exemplified as a rectangular parallelepiped-shaped space having left and right lengths relatively greater than front and rear lengths. However, a shape, size, or the like of the internal space 210 may be changed in various manners, as necessary, and is not necessarily limited to the example.

The insulating casing 200 of the present embodiment may be vertically divided. That is, the insulating casing 200 may include an upper insulating casing 220 and a lower insulating casing 230. For example, the insulating casing 200 may include an upper insulating casing 220 having a first traverse overlapping portion 241, and a lower insulating casing 230 having a second traverse overlapping portion 242 overlapping the first traverse overlapping portion 241 to form a traverse overlapping portion 240

The upper insulating casing 220 may form an upper region of the insulating casing 200, and the lower insulating casing 230 may form a lower region of the insulating casing 200. The upper insulating casing 220 and the lower insulating casing 230 may be vertically combined with each other to form a single internal space 210 in which the electrode assembly 120 is accommodated.

The upper insulating casing 220 may include an upper rear surface portion 221, first and second upper side surface portions 222 and 223, first and second upper front surface portions 224a and 224b, and an upper surface portion 225.

The upper rear surface portion 221 may have a predetermined horizontal width and vertical height, and may be formed to extend in an approximately rectangular shape. The first upper side surface portion 222 may be formed to extend from one-side end (a left side in the drawing) of the upper rear surface portion 221, and may be bent forward with respect to a boundary line with the upper rear surface portion 221. Similarly, the second upper side surface portion 223 may be formed to extend from an opposite-side end (a right side in the drawing) of the upper rear surface portion 221, and may be bent forward with respect to a boundary line with the upper rear surface portion 221. In the present embodiment, the first and second upper side surface portions 222 and 223 are exemplified as having a width, substantially less than that of the upper rear surface portion 221.

The first upper front surface portion 224a may be formed to extend from one-side end (a front end in the drawing) of the first upper side surface portion 222, and may be bent laterally (a right side in the drawing) with respect to a boundary line with the first upper side surface portion 222. Similarly, the second upper front surface portion 224b may be formed to extend from one-side end (a front end in the drawing) of the second upper side surface portion 223, and may be bent laterally (a left side in the drawing) with respect to a boundary line with the second upper side surface portion 223. The first and second upper front surface portions 224a and 224b may form an upper front surface portion 224 corresponding to the upper rear surface portion 221. The upper front surface portion 224 and the upper rear surface portion 221 may be disposed to face each other with the internal space 210 interposed therebetween.

The upper surface portion 225 may be formed to extend horizontally from an upper end of the upper rear surface portion 221. The upper surface portion 225 may be bent forward with respect to a boundary line with the upper rear surface portion 221 to shield an upper end of the internal space 210. In addition, a plurality of paths for components of the electrode assembly 120 or the cap plate 130 may be formed in the upper surface portion 225. In the present embodiment, the upper surface portion 225 may have first and second electrode paths 225a and 225b for a negative electrode tab 122a and a positive electrode tab 121a, a vent path 225c for a vent 133 and an injection port path 225d for an electrolyte injection port 134.

The lower insulating casing 230 may include a lower rear surface portion 231, first and second lower side surface portions 232 and 233, first and second lower front surface portions 234a and 234b, and a bottom surface portion 235.

The lower rear surface portion 231 to the bottom surface portion 235 may be formed to be substantially similar to the upper rear surface portion 221 to the upper surface portion 225 described above. The lower rear surface portion 231 may have a predetermined horizontal width and vertical height, and may be formed to extend in an approximately rectangular shape. In addition, the first lower side surface portion 232 may be formed to extend from one-side end (a left side in the drawing) of the lower rear surface portion 231, and may be bent forward with respect to a boundary line with the lower rear surface portion 231, and the second lower side surface portion 233 may be formed to extend from an opposite-side end (a right side in the drawing) of the lower rear surface portion 231, and may be bent forward with respect to a boundary line with the lower rear surface portion 231.

The first lower front surface portion 234a may be formed to extend from one-side end (a front end in the drawing) of the first lower side surface portion 232, and may be bent laterally (a right side in the drawing) with respect to a boundary line with the first lower side surface portion 232, and the second lower front portion 234b may be formed to extend from one-side end (a front end in the drawing) of the second lower side surface portion 233, and may be bent laterally (a left side in the drawing) with respect to a boundary line with the second lower side surface portion 233. The first and second lower front portions 234a and 234b may form a lower front surface portion 234 corresponding to the lower rear surface portion 231.

The bottom surface portion 235 may be formed to extend horizontally from a lower end of the lower rear portion 231. The bottom surface portion 235 may be bent forward with respect to a boundary line with the lower rear surface portion 231 to shield a lower end of the internal space 210. An electrolyte flow hole 235a for allowing an electrolyte to flow into the internal space 210 of the insulating casing 200 may be formed in the bottom surface portion 235, as necessary. A plurality of electrolyte flow holes 235a may be disposed on the bottom surface portion 235 to be spaced apart from each other.

The insulating casing 200 according to the present embodiment may include a transverse overlapping portion 240.

The transverse overlapping portion 240 may be formed by a lower end region of the upper insulating casing 220 overlapping an upper end region of the lower insulating casing 230. The transverse overlapping portion 240 may be formed to extend so as to surround a circumference of the insulating casing 200 in a transverse direction.

The transverse overlapping portion 240 may have a predetermined vertical height H1. In some embodiments, the height H1 may be 3% to 20% with respect to an overall height of the insulating casing 200.

The transverse overlapping portion 240 may have a closed shape surrounding the circumference of the insulating casing 200 in plan view. In the present embodiment, the transverse overlapping portion 240 may have a closed rectangular shape in plan view. The transverse overlapping portion 240 may function as a reinforcing means for limiting expansion in the transverse direction in the corresponding region. For example, the transverse overlapping portion 240 may function as a reinforcing means for suppressing swelling generated in the internal space 210.

In the present embodiment, the transverse overlapping portion 240 may be disposed in a central region of the insulating casing 200 in a height direction. The transverse overlapping portion 240 disposed at the center may function as a reinforcing means for suppressing swelling in the central region of the insulating casing 200. In general, swelling, generating a relatively large displacement in the central region, may be considered.

The above-described arrangement of the transverse overlapping portion 240 may be implemented in a manner in which overall heights of the upper insulating casing 220 and the lower insulating casing 230 are formed to be equal to each other. That is, the transverse overlapping portion 240, disposed at the center of the insulating casing 200 in the height direction, may be implemented by allowing a lower end of the upper insulating casing 220 and an upper end of the lower insulating casing 230 to overlap each other by a predetermined region.

However, the transverse overlapping portion 240 may be disposed at various positions other than the exemplified central region, as necessary, and is not necessarily limited to the exemplified central region. For example, in other embodiments, the transverse overlapping portion 240 may be disposed in an upper region of the central region more adjacent to an upper end of the insulating casing 200, or in a lower region of the central region more adjacent to a lower end of the insulating casing 200. Alternatively, a position of the transverse overlapping portion 240 may be appropriately selected as a point requiring reinforcement through testing and analysis for a specific type of secondary battery.

The transverse overlapping portion 240 may be formed by a first transverse overlapping portion 241 of the upper insulating casing 220 overlapping a second transverse overlapping portion 242 of the lower insulating casing 230.

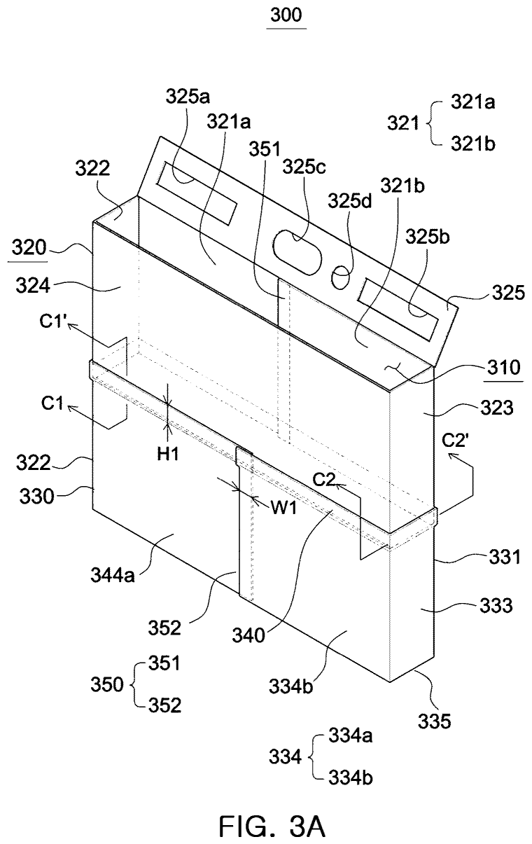

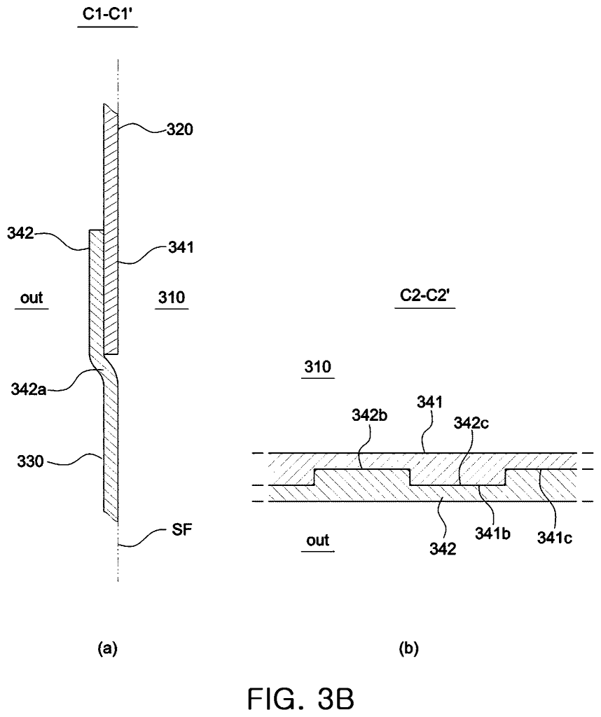

The first transverse overlapping portion 241 may be formed in the lower end region of the upper insulating casing 220, and the second transverse overlapping portion 242 may be formed in the upper end region of the lower insulating casing 230. In the present embodiment, the first transverse overlapping portion 241 may be disposed on the outside of the internal space 210, and the second transverse overlapping portion 242 may be disposed on the inside of the internal space 210, such that the first and second transverse overlapping portions 241 and 242 may overlap each other in a thickness direction. However, as illustrated in FIG. 3A, internal and external positions of the first and second transverse overlapping portions 241 and 242 may be appropriately changed, as necessary, and are not necessarily limited to the example.

The first transverse overlapping portion 241 may be formed to extend along a circumference of the upper insulating casing 220 in the lower end region of the upper insulating casing 220. That is, the t transverse overlapping portion 241 may be formed to extend along a lower end region of each of the first upper front surface portion 224a, the first upper side surface portion 222, the upper rear surface portion 221, the second upper side surface portion 223, and the second upper front surface portion 224b.

Similarly, the second transverse overlapping portion 242 may be formed to extend along a circumference of the lower insulating casing 230 in the upper end region of the lower insulating casing 230. That is, the second transverse overlapping portion 242 may be formed to extend along a upper end region of each of the first lower front surface portion 234a, the first lower side surface portion 232, the lower rear surface portion 231, the second lower side surface portion 233, and the second lower front surface portion 234b.

The first and second transverse overlapping portions 241 and 242 may be bonded to each other by a predetermined bonding means to form a single transverse overlapping portion 240. In some embodiments, the first and second transverse overlapping portions 241 and 242 may be bonded to each other by thermal fusion or an adhesive means. The adhesive means may include an adhesive, an adhesive resin, an insulating tape, or the like.

The insulating casing 200 according to the present embodiment may include a longitudinal overlapping portion 250.

A portion of the longitudinal overlapping portion 250 may be formed by one-side end region of the upper insulating casing 220 overlapping a corresponding opposite-side end region of the upper insulating casing 220. In addition, a remaining portion of the longitudinal overlapping portion 250 may be formed by one-side end region of the lower insulating casing 230 overlapping a corresponding opposite-side end region of the lower insulating casing 230. For convenience, in the present description, the portion of the longitudinal overlapping portion 250 formed by overlapping of the upper insulating casing 220 may be referred to as a first longitudinal overlapping portion 251, and the remaining portion of the longitudinal overlapping portion 250 formed by overlapping of the lower insulating casing 230 may be referred to as a second longitudinal overlapping portion 252. Accordingly, the longitudinal overlapping portion 250 may include the first and second longitudinal overlapping portions 251 and 252.

The first longitudinal overlapping portion 251 may be formed to extend vertically from an upper end to a lower end of the upper insulating casing 220. In addition, the first longitudinal overlapping portion 251 may have a predetermined width W1 in left and right directions. In some embodiments, the height H1 of the transverse overlapping portion may be formed to be slightly greater than 240 a width W1 of an overlap between the first and second longitudinal overlapping portions 251 and 252. For example, in the present embodiment, the width W1 of the first longitudinal overlapping portion 251 may be formed to be about 50% of the height H1 of the transverse overlapping portion 240. This takes into account that unlike the transverse overlapping portion 240, the first longitudinal overlapping portion 251 has a main function in bonding.

Similarly, the second longitudinal overlapping portion 252 may extend from the upper end to the lower end of the lower insulating casing 230. In addition, the second longitudinal overlapping portion 252 may have a predetermined horizontal width W1. In the present embodiment, the second longitudinal overlapping portion 252 is exemplified as having a width W1 corresponding to that of the first longitudinal overlapping portion 251.

In the present embodiment, the first and second longitudinal overlapping portions 251 and 252 may all be disposed on a front surface of the insulating casing 200, and may be disposed to be vertically continuous in the left and right centers of the insulating casing 200. The first and second longitudinal overlapping portions 251 and 252 may intersect the transverse overlapping portion 240 in an approximately ‘+’ shape on the front surface of the insulating casing 200. Such an arrangement may bring convenience in an automating bonding operation, inspection and determination of bonding defects, or the like.

However, arrangements of the first second longitudinal overlapping portions 251 and 252 is not necessarily limited to the examples. For example, in some embodiments, the first and second longitudinal overlapping portions 251 and 252 may be disposed at positions deviating from the left and right centers of the insulating casing 200, or may be disposed such that the first longitudinal overlapping portion 251 and the second longitudinal overlapping portion 252 are not vertically continuous. In addition, in other embodiments, the first and second longitudinal overlapping portions 251 and 252 may be disposed on different surfaces of the insulating casing 200, respectively. For example, FIG. 3A or the like illustrates a case in which the first and second longitudinal overlapping portions 251 and 252 are disposed on a front surface or a rear surface, respectively.

The first longitudinal overlapping portion 251 may be formed by a first-first longitudinal overlapping portion 251a formed on one-side end of the upper insulating casing 220 overlapping a first-second longitudinal overlapping portion 251b formed on a corresponding opposite-side end of the upper insulating casing 220. In addition, the second longitudinal overlapping portion 252 may be formed by a second-first longitudinal overlapping portion 252a formed on one-side end of the lower insulating casing 230 overlapping a second-second longitudinal overlapping portion 252b formed on a corresponding opposite-side end of the lower insulating casing 230. A structure in which the first and second longitudinal overlapping portions 251 and 252 overlap each other may be substantially similar to that of the transverse overlapping portion 240 described above.

The insulating casing 200 including the upper insulating casing 220 and the lower insulating casing 230 may be formed as a plate formed of an insulating plastic material having a predetermined thickness. For example, a portion or all of the insulating casing 200 may include polyamide, polyacetal, polycarbonate, polyethylene terephthalate, modified polyphenylene oxide, fluorine resin, polyphenylene sulfide, polyarylate, polyethersulfone, polyetherether ketone, polyetherimide, or the like.

FIG. 2D is a schematic diagram illustrating an electrode assembly being packaged by an insulating casing illustrated in FIG. 2A.

Referring to FIG. 2D, the upper insulating casing 220 and the lower insulating casing 230 may be coupled to each other to form an internal space (210 of FIG. 2A) for accommodating the electrode assembly 120. For reference, in the present drawing, the upper insulating casing 220 is illustrated in a partially deployed form for ease of description.

In some embodiments, remaining components of the upper insulating casing 220 and the lower insulating casing 230, excluding the upper surface portion 225, may be bonded in advance. That is, in the upper insulating casing 220, the upper rear surface portion 221, the first and second upper side surface portions 222 and 223, and the first and second upper front surface portions 224a and 224b may be bent with respect to each boundary line, and the first-first longitudinal overlapping portion 251a and the first-second longitudinal overlapping portion 251b may overlap each other and be bonded to each other. The upper surface portion 225 may be disposed in a state in which an upper end of the internal space 210 is opened for insertion of the electrode assembly 120.

In addition, in the lower insulating casing 230, the lower rear surface portion 231, the first and second lower side surface portions 232 and 233, and the first and second lower front surfaces 234a and 234b may be bent with respect to each boundary line, and the second-first longitudinal overlapping portion 252a and the second-second longitudinal overlapping portion 252b may overlap each other and be bonded to each other. In addition, the bottom surface portion 235 may close a bottom surface of the lower insulating casing 230.

The upper insulating casing 220 and the lower insulating casing 230 may form the transverse overlapping portion 240, and may be vertically bonded to each other. The electrode assembly 120 may be inserted into the internal space 210 through an upper end of the upper insulating casing 220 in a state in which the upper insulating casing 220 and the lower insulating casing 230 are vertically bonded to each other as described above. When the electrode assembly 120 is entirely inserted, the upper surface portion 225 may be bent and bonded to shield the upper end of the internal space 210. Accordingly, the electrode assembly 120 may be disposed in a state of being accommodated in the insulating casing 200, excluding some components such as an electrode tab or the like.

In the above-described insulating casing 200, the transverse overlapping portion 240 may be formed to surround a circumference of the internal space 210, in which the electrode assembly 120 is accommodated, in the transverse direction, and the transverse overlapping portion 240 may function as a reinforcing means for swelling or the like in a corresponding region.

FIG. 3A is a schematic perspective view of an insulating casing according to another embodiment.

For convenience, differences between the following embodiments and the above-described embodiments will be mainly described.

Referring to FIG. 3A, an insulating casing 300 of the present embodiment may include an upper insulating casing 320 and a lower insulating casing 330, and may be vertically divided. The upper insulating casing 320 and the lower insulating casing 330 may form an internal space 310 for accommodating an electrode assembly 120.

The upper insulating casing 320 may include first and second upper rear surface portions 321a and 321b, first and second upper side surface portions 322 and 323, an upper front surface portion 324, and an upper surface portion 325. In contrast to the above-described embodiment, the upper insulating casing 320 of the present embodiment may be partially different from that of the above-described embodiment in that an upper rear surface portion 321 is divided into first and second upper rear surface portions 321a and 321b.

The lower insulating casing 330 may include a lower rear surface portion 331, first and second lower side surfaces 332 and 333, first and second lower front surfaces 334a and 334b, and a bottom surface portion 335. In the present embodiment, the lower insulating casing 330 may be formed substantially similar to the above-described embodiment.

The insulating casing 300 of the present embodiment may include a transverse overlapping portion 340. The transverse overlapping portion 340 may be formed by a lower end region of the upper insulating casing 320 overlapping an upper end region of the lower insulating casing 330, and may be formed to extend so as to surround a circumference of the insulating casing 300 in a transverse direction. The transverse overlapping portion 340 may have a closed shape surrounding the circumference of the insulating casing 300, and thus may function as a reinforcing means for limiting expansion in the transverse direction. The transverse overlapping portion 340 of the present embodiment may be partially different from that of the above-described embodiment in that the lower end region of the upper insulating casing 320 is disposed on the inside of the transverse overlapping portion 340 and the upper end region of the lower insulating casing 330 is disposed on the outside of the transverse overlapping portion 340, such that the lower end region of the upper insulating casing 320 and the upper end region of the lower insulating casing 330 overlap each other in a thickness direction.

The insulating casing 300 of the present embodiment may include a longitudinal overlapping portion 350. The longitudinal overlapping portion 350 may include a first longitudinal overlapping portion 351 and a second longitudinal overlapping portion 352, and the first longitudinal overlapping portion 351 may be formed by one-side end region of the upper insulating casing 320 overlapping a corresponding opposite-side end region of the upper insulating casing 320. The second longitudinal overlapping portion 352 may be formed by one-side end region of the lower insulating casing 330 overlapping a corresponding opposite-side end region of the lower insulating casing 330.

The first and second longitudinal overlapping portions 351 and 352 of the present embodiment may be partially different from those of the above-described embodiment in that the first and second longitudinal overlapping portions 351 and 352 are disposed on a front surface or a rear surface of the insulating casing 300. That is, the first longitudinal overlapping portion 351 may be disposed on the rear surface of the insulating casing 300 by the first upper rear surface portion 321a overlapping the second upper rear surface portion 321b, and the second longitudinal overlapping portion 352 may be disposed on the front surface of the insulating casing 300 by the first lower front surface portion 334a overlapping the second lower front surface portion 334b. In addition, in the present embodiment, a width W1 of the longitudinal overlapping portion 350 may be formed to correspond to a height H1 of the transverse overlapping portion 340.

(a) of FIG. 3B is a schematic cross-sectional view taken along line C1-C1′ of FIG. 3A.

Referring to (a) of FIG. 3B, a first traverse overlapping portion 341 may be formed in a lower end region of the upper insulating casing 320, and a second traverse overlapping portion 342 may be formed in an upper end region of the lower insulating casing 330. The first and second traverse overlapping portions 341 and 342 may overlap each other in a thickness direction of the insulating casing 300 to form a single traverse overlapping portion 340.

In (a) of FIG. 3B, right-side regions of the first and second traverse overlapping portions 341 and 342 may be a direction toward the internal space 310 of the insulating casing 300, and a left-side regions of the first and second traverse overlapping portions 341 and 342 may be a direction toward the outside OUT of the insulating casing 300. In the present embodiment, the first traverse overlapping portion 341 may be disposed toward the internal space 310, and the second traverse overlapping portion 342 may be disposed toward the outside OUT.

Here, the second transverse overlapping portion 342 of the present embodiment may be formed to extend from the lower insulating casing 330 through a bending region 342a. The bending region 342a may be formed to extend so as to be slightly bent toward the outside OUT of the insulating casing 300 such that an internal surface of the insulating casing 300 forms a plane SF at a bonding portion between the first and second traverse overlapping portions 341 and 342. The bending region 342a may prevent a protruding portion from being formed on an internal surface of the insulating casing 300 in a region in which the transverse overlapping portion 340 is formed. That is, the bending region 342a may allow an internal surface of the first transverse overlapping portion 341 disposed toward the internal space 310 and an internal surface of the lower insulating casing 330 disposed toward the internal space 310 to form a corresponding single plane SF, thereby bringing advantages such as insertion of the electrode assembly 120, optimization of an internal space, or the like.

A case in which the bending region 342a is formed in the second horizontal overlapping portion 342 according to the illustrated drawing has been described above, but a target, a position, or the like of the bending region 342a may be appropriately changed and applied according to an arrangement relationship between respective components. For example, in the embodiment described above with reference to FIG. 2A or the like, the bending region 342a may be formed in the first traverse overlapping portion 241. In addition, the bending region 342a described above may be similarly applied to the first longitudinal overlapping portion 351 or the second longitudinal overlapping portion 352, as necessary.

(b) of FIG. 3B is a schematic cross-sectional view taken along line C2-C2′ of FIG. 3A.

Referring to (b) of FIG. 3B, the first transverse overlapping portion 341 and the second transverse overlapping portion 342 may be coupled to each other in a structure in which protruding ribs 341b and 342b and rib grooves 341c and 342c are engaged with each other, as necessary.

The first traverse overlapping portion 341 may include a first protruding rib 341b formed to protrude toward the outside of the insulating casing 300, the first protruding rib 341b formed as a plurality of first protruding ribs 341b, the plurality of first protruding ribs 341b disposed to be spaced apart from each other at a predetermined interval in an extension direction of the first traverse overlapping portion 341, and a first rib groove 342c formed between a pair of adjacent first protruding ribs 341c, the first rib groove 341c disposed repeatedly and alternately with the first protruding rib 341c in the extension direction.

The second traverse overlapping portion 342 may include a second protruding rib 342b formed as a plurality of first protruding ribs 342b, the plurality of second protruding ribs 342b disposed to be spaced apart from each other at a predetermined interval in the extension direction of the second traverse overlapping portion 342, the second protruding rib 342b coupled to the first rib groove 341c to be engaged with the first rib groove 341c, and a second rib groove 342c formed between a pair of adjacent second protruding ribs 342b, the second rib groove 342c coupled to the first protruding rib 341b be engaged with the first protruding rib 341b.

Specifically, the first traverse overlapping portion 341 may include a first protruding rib 341b and a first rib groove 341c. The first protruding rib 341b may be formed to protrude toward the outside OUT of the insulating casing 300, and a plurality of first protruding ribs 341b may be disposed to be spaced apart from each other by a predetermined interval in an extension direction of the first traverse overlapping portion 341. The first rib groove 341c may be formed between a pair of adjacent first protruding ribs 341b. In the present embodiment, the first protruding rib 341b and the first rib groove 341c may be alternately and repeatedly disposed in the extension direction of the first traverse overlapping portion 341.

The second traverse overlapping portion 342 may include a second protruding rib 342b and a second rib groove 342c. The second protruding rib 342b may be formed to protrude toward the internal space 310 of the insulating casing 300, and a plurality of second protruding ribs 342b may disposed to be spaced apart from each other at a predetermined interval in an extension direction of the second traverse overlapping portion 342. In addition, the second protruding rib 342b may be formed to correspond to the first rib groove 341c, and may be coupled to the first rib groove 341c to be engaged with the first rib groove 341c. The second rib groove 342c may be formed between a pair of adjacent second protruding ribs 342b. In the present embodiment, the second protruding rib 342b and the second rib groove 342c may be alternately and repeatedly disposed in the extension direction of the second traverse overlapping portion 342. The second rib groove 342c may be formed to correspond to the first protruding rib 341b, and may be coupled to the first protruding rib 341b to be engaged with the first protruding rib 341b.

As described above, the first protruding rib 341b may be coupled to the second rib groove 342c to be engaged with the second rib groove 342c, and the second protruding rib 342b may be coupled to the first rib groove 341c to be engaged with the first rib groove 341c, such that the first and second traverse overlapping portions 341 and 342 may secure an additional support structure in the extension direction. That is, through a structure in which the protruding ribs 341b and 342b and the rib grooves 341c and 342c are engaged with each other, a predetermined support structure may be provided in the extension direction of each of the first and second traverse overlapping portions 341 and 342. The support structure may function to more effectively limit expansion of the first and second traverse overlapping portions 341 and 342.

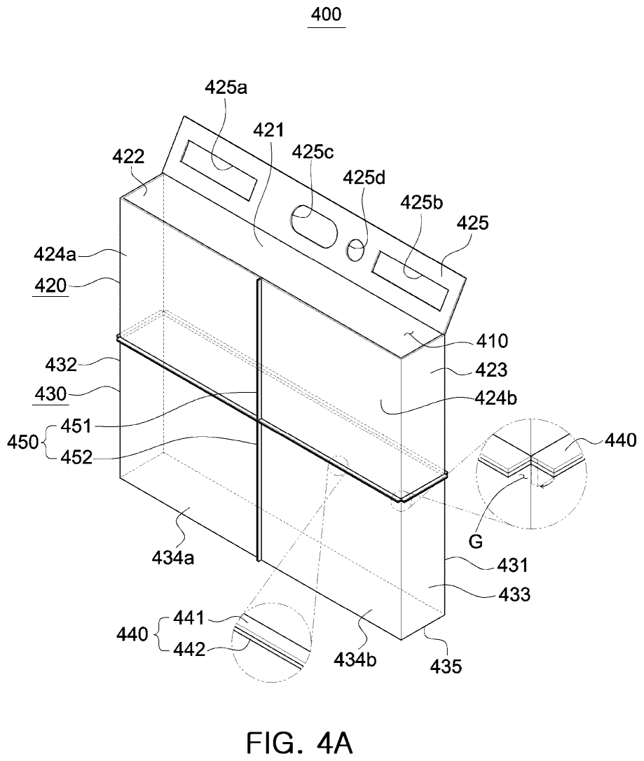

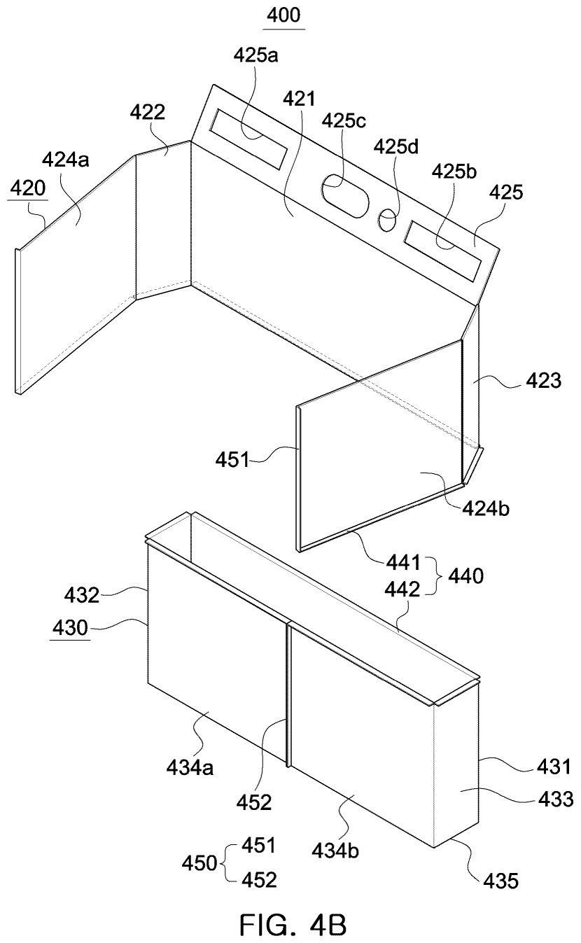

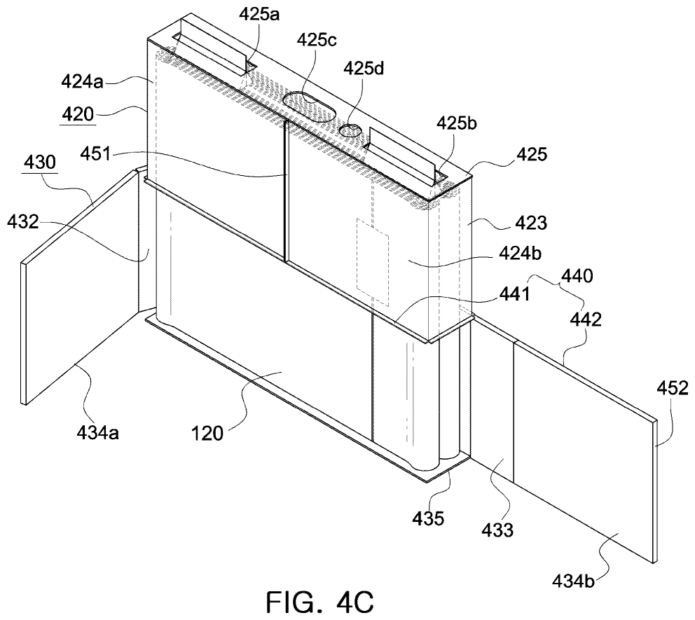

FIG. 4A is a schematic perspective view of an insulating casing according to another embodiment. FIG. 4B is a schematic partial deployment view of an insulating casing illustrated in FIG. 4A.

Referring to FIGS. 4A and 4B, an insulating casing 400 according to the present embodiment may include an upper insulating casing 420 and a lower insulating casing 430. In a similar manner to the embodiment described with reference to FIG. 2A, the upper insulating casing 420 may include an upper rear surface portion 421, first and second upper side surface portions 422 and 423, first and second upper front surface portions 424a and 424b, and the lower insulating casing 430 may include a lower rear surface portion 431, first and second lower side surface portions 432 and 433, first and second lower front surface portions 434a and 434b, and a bottom surface portion 435. The upper insulating casing 420 and the lower insulating casing 430 may form an internal space 410 for accommodating an electrode assembly 120.

The insulating casing 400 of the present embodiment may include a transverse overlapping portion 440. Here, the transverse overlapping portion 440 of the present embodiment may be formed to be slightly bent toward the outside of the internal space 410. Specifically, a lower end region of the upper insulating casing 420 may be slightly bent to the outside of the internal space 410 to form a first transverse overlapping portion 441. In addition, an upper end region of the lower insulating casing 430 may be slightly bent to the outside of the internal space 410 to form a second transverse overlapping portion 442. The transverse overlapping portion 440 of the present embodiment may be formed by the first and second transverse overlapping portions 441 and 442 having such bent portions, vertically overlapping each other.

The transverse overlapping portion 440 described above may have further improved structural rigidity through a bending shape of the transverse overlapping portion 440. In addition, in the transverse overlapping portion 440 described above, respective ends of the first and second transverse overlapping portions 441 and 442 may be exposed to the outside of the internal space 410, such that a bonding process between the first and second transverse overlapping portions 441 and 442 may be more easily performed. In addition, the transverse overlapping portion 440 described above may prevent protruding portions from being formed on internal surfaces of the upper insulating casing 420 and the lower insulating casing 430 (see FIG. 3B), thereby bringing advantages such as insertion of the electrode assembly 120, optimization of an internal space, or the like.

The transverse overlapping portion 440 described above may be appropriately bent toward an external surface of the insulating casing 300 after bonding, as necessary. FIG. 4A illustrates a case in which the transverse overlapping portion 440 disposed on a right side surface of the insulating casing 400 is bent. In this case, the transverse overlapping portion 440 may be bent through a predetermined external force to be adjacent to an external surface of the insulating casing 400 after bonding. In addition, in this case, the transverse overlapping portion 440 may be partially divided with a predetermined gap G at a position at which respective surfaces of the insulating casing 400 are in contact with each other, such that the transverse overlapping portion 440 may be bent on the respective surfaces of the insulating casing 400.

The insulating casing 400 of the present embodiment may include a longitudinal overlapping portion 450. The longitudinal overlapping portion 450 may include a first longitudinal overlapping portion 451 and a second longitudinal overlapping portion 452, and the first longitudinal overlapping portion 451 may be formed by one-side end region of the upper insulating casing 420 overlapping a corresponding opposite-side end region of the upper insulating casing 420. The second longitudinal overlapping portion 452 may be formed by one-side end region of the lower insulating casing 430 overlapping a corresponding opposite-side end region of the lower insulating casing 430. In the present embodiment, the first and second longitudinal overlapping portions 451 and 452 may all be disposed on a front surface of the insulating casing 400 in a similar manner to the embodiment of FIG. 2A or the like.

The longitudinal overlapping portion 450 of present embodiment may be formed to have a structure in which respective end regions of the longitudinal overlapping portion 450 are slightly bent and bonded to each other, as necessary, in a similar manner to the above-described transverse overlapping portion 440.

FIG. 4C is a schematic diagram illustrating an electrode assembly being packaged by an insulating casing illustrated in FIG. 4A.

Referring to FIG. 4C, the upper insulating casing 420 and the lower insulating casing 430 may be coupled to each other to form an internal space (410 of FIG. 4A) for accommodating the electrode assembly 120. For reference, in the present drawing, the lower insulating casing 430 is illustrated in a partially deployed form for ease of description.

In some embodiments, remaining components of the upper insulating casing 420 and the lower insulating casing 430, excluding an upper surface portion 425, may be bonded in advance. The transverse overlapping portion 440 and the longitudinal overlapping portion 450 may be appropriately bent after bonding, as necessary. In some embodiments, only a portion of the transverse overlapping portion 440 and the longitudinal overlapping portion 450 may be bent, and a remaining portion of the transverse overlapping portion 440 and the longitudinal overlapping portion 450 may be maintained in a deployed state after bonding. For example, the transverse overlapping portion 440 may be maintained in a deployed state after bonding, and the longitudinal overlapping portion 450 may be appropriately bent after bonding. For another example, a portion of the transverse overlapping portion 440, corresponding to front and rear surfaces of the insulating casing 400, may be maintained in a deployed state after bonding, and a remaining portion of the transverse overlapping portion 440, corresponding to left and right side surfaces of the insulating casing 400, may be appropriately bent after bonding.

The electrode assembly 120 may be inserted into the internal space 410 through an upper end of the upper insulating casing 420 in a state in which the upper insulating casing 420 and the lower insulating casing 430 are vertically bonded to each other as described above, and then the upper surface portion 425 may be bent and bonded to shield the internal space 410. Such a structure may be similar to that described above with reference to FIG. 2D or the like.

As described above, a secondary battery according to embodiments of the present disclosure may include an insulating casing accommodating an electrode assembly therein. The insulating casing may be divided into an upper insulating casing and a lower insulating casing, and the upper insulating casing and lower insulating casing may form a transverse overlapping portion surrounding a circumference of an internal space in a transverse direction. The transverse overlapping portion may function as a reinforcing means for suppressing swelling. In addition, in some cases, the insulating casing may include a longitudinal overlapping portion, and the longitudinal overlapping portion may vertically extend from one surface thereof surrounding the internal space to assist the above-described reinforcing function or the like.

Only specific examples of implementations of certain embodiments are described. Variations, improvements and enhancements of the disclosed embodiments and other embodiments may be made based on the disclosure of this patent document.

What is claimed is:

1. A secondary battery comprising:
an electrode assembly;
an insulating casing accommodating the electrode assembly therein; and
a case accommodating the insulating casing therein,
wherein the insulating casing includes:
an upper insulating casing having a first traverse overlapping portion; and
a lower insulating casing having a second traverse overlapping portion overlapping the first traverse overlapping portion to form a traverse overlapping portion.

2. The secondary battery of claim 1, wherein the transverse overlapping portion is formed to have a closed shape surrounding a circumference of the insulating casing in plan view.

3. The secondary battery of claim 1, wherein the transverse overlapping portion is disposed in a central region of the insulating casing in a height direction.

4. The secondary battery of claim 1, wherein the first and second transverse overlapping portions overlap each other in a thickness direction of the insulating casing, and are coupled to each other through thermal fusion or an adhesive means.

5. The secondary battery of claim 1, wherein
one-side end of the upper insulating casing overlaps a corresponding opposite-side end of the upper insulating casing to form a first longitudinal overlapping portion, and
one-side end of the lower insulating casing overlaps a corresponding opposite-side end of the lower insulating casing to form a second longitudinal overlapping portion.

6. The secondary battery of claim 5, wherein the first and second longitudinal overlapping portions are disposed on one surface of the insulating casing to vertically correspond to each other, and are formed to intersect the transverse overlapping portion in a “+” shape.

7. The secondary battery of claim 5, wherein the transverse overlapping portion is formed to have a predetermined height by the first and second transverse overlapping portions overlapping each other, and the height is formed to be slightly greater than a width of an overlap between the first and second longitudinal overlapping portions.

8. The secondary battery of claim 1, wherein one of the first and second traverse overlapping portions is formed to extend through a bending region, and the bending region is formed to be bent toward the outside of the insulating casing such that an internal surface of the insulating casing forms a plane at a bonding portion between the first and second traverse overlapping portions.

9. The secondary battery of claim 1, wherein the first traverse overlapping portion includes:
a first protruding rib formed to protrude toward the outside of the insulating casing, the first protruding rib formed as a plurality of first protruding ribs, the plurality of first protruding ribs disposed to be spaced apart from each other at a predetermined interval in an extension direction of the first traverse overlapping portion; and
a first rib groove formed between a pair of adjacent first protruding ribs, the first rib groove disposed repeatedly and alternately with the first protruding rib in the extension direction.

10. The secondary battery of claim 9, wherein
the second traverse overlapping portion includes:
a second protruding rib formed as a plurality of first protruding ribs, the plurality of second protruding ribs disposed to be spaced apart from each other at a predetermined interval in the extension direction of the second traverse overlapping portion, the second protruding rib coupled to the first rib groove to be engaged with the first rib groove; and
a second rib groove formed between a pair of adjacent second protruding ribs, the second rib groove coupled to the first protruding rib be engaged with the first protruding rib.

11. The secondary battery of claim 1, wherein
the first traverse overlapping portion is formed by a lower end region of the upper insulating casing being bent,
the second traverse overlapping portion is formed by an upper end region of the lower insulating casing being bent so as to correspond to the first traverse overlapping portion, and
the traverse overlapping portion is formed by bent portions of the first and second traverse overlapping portions, vertically overlapping each other.

12. The secondary battery of claim 11, wherein
the first traverse overlapping portion is formed by the lower end region of the upper insulating casing being bent toward the outside of an internal space thereof, and
the second traverse overlapping portion is formed by the upper end region of the lower insulating casing being bent toward the outside of an internal space thereof so as to correspond to the first traverse overlapping portion.

13. The secondary battery of claim 11, wherein at least a portion of the traverse overlapping portion is bent toward an external surface of the insulating casing after bonding between the first and second traverse overlapping portions.

14. The secondary battery of claim 13, wherein the traverse overlapping portion is divided with a predetermined gap at a position at which respective surfaces of the insulating casing are in contact with each other.

15. The secondary battery of claim 1, wherein
the upper insulating casing includes an upper surface portion shielding an upper side of the electrode assembly, the upper surface portion having at least one of a first electrode path, a second electrode path, a vent path, and an injection port path, and
the lower insulating casing includes a bottom surface portion shielding a lower side of the electrode assembly, the bottom surface portion having an electrolyte flow hole.

16. The secondary battery of claim 1, wherein the insulating casing is formed as a plate formed of insulating plastic material having a predetermined thickness.
